(19) United States
(12) Patent Application Publication
(10) Pub. No.: US 2011/0055547 A1
(43) Pub. Date: Mar. 3, 2011

(54) PERSONAL INFORMATION MANAGEMENT AND DELIVERY MECHANISM

(75) Inventors: Gen-Cher Lee, Changhua County (TW); Der-Tsai Lee, Taipei City (TW); Laurent Lin, Taipei City (TW)

(73) Assignee: Academia Sinica, Taipei (TW)

(21) Appl. No.: 12/870,403

(22) Filed: Aug. 27, 2010

Related U.S. Application Data
(60) Provisional application No. 61/237,361, filed on Aug. 27, 2009.

(51) Int. Cl. G06F 12/14; H04L 9/00

(52) U.S. Cl. 713/150; 713/189

(57) ABSTRACT

Some general aspects relate to secured means for managing and delivering personal information, for example, in the context of electronic commerce. A request from a first entity to encrypt personal information includes a first specification of the personal information to be encrypted. An encrypted specification of the personal information is then generated according to an encoding strategy. The encrypted specification of the personal information is provided to the first entity for subsequent use by a personal information user. A second entity sends a request to decrypt the encrypting specification of the personal information. Upon determining that the second entity is an authorized personal information receiver, a decrypted specification of the personal information is formed according to a decoding strategy determined based on an analysis of the encrypted specification. This decrypted specification of the personal information is then provided to the second entity.

### CROSS-REFERENCE TO RELATED APPLICATIONS

This application claims priority to U.S. Provisional Application Ser. No. 61/237,361, filed Aug. 27, 2009, and entitled “Personal Information Management and Delivery Mechanism,” the contents of which are incorporated herein by reference.

### BACKGROUND

Electronic commerce (e-commerce) involves the buying and selling of products or services over electronic systems such as the Internet. As Internet usage has become more widespread, the number of e-commerce applications and parties to e-commerce transactions has exploded exponentially.

Various types of personal information about an individual are collected, used, and/or stored during the course of an e-commerce transaction. Examples of such personal information include an individual's real name, telephone number, street address, financial account number, credit card information, identity card number, personal history, personal medical record, username and password, or other categories of sensitive information that a user may not wish to be easily accessed by third parties.

E-commerce application providers typically assert that personal information obtained during the course of an e-commerce transaction will be safeguarded in accordance with a privacy policy. In general, privacy policies specify what personal information is collected, how that personal information is stored or used, and who and under what conditions that personal information may be sold to, shared with, or rented to. However, despite such assurances, personal information about individuals has been revealed due to negligent or purposeful actions by information managers in violation of the privacy policies. Such actions have caused problems for victims, such as identity theft and fraud, resulting in damages and huge financial loss or otherwise.

An individual may desire to manage and control the manner in which certain personal information, such as the individual's real name, telephone number, street address, financial account number, credit card information, identity card number, personal history, personal medical records, etc., is used, provided, or otherwise delivered as part of an electronic transaction.

Three conventional techniques for enabling an individual to control the manner in which certain personal information are stored and/or delivered are described in U.S. Pat. No. 6,564,323, U.S. Pat. No. 5,524,049, and U.S. Publication No. 20070136202.

The abstract of U.S. Pat. No. 6,564,323 states:
A personal information controlling method and apparatus for controlling pieces of personal information and for outputting a specific piece of personal information on a personal information registrant to a personal information referencer in response to a request by the personal information registrant. The invention provides that an inquiry code is issued by generating and outputting an inquiry code in accordance with an instruction from the personal information registrant. The inquiry code is to be used by the personal information referencer to acquire the specific piece of personal information as an identification of the specific piece of personal information. The invention also provides that personal information is acquired by requesting the personal information referencer to enter the inquiry code and outputting the specific piece of personal information identified by the inquiry code if the inquiry code entered by the personal information referencer matches the issued inquiry code.

The abstract of U.S. Pat. No. 5,524,049 states:
A communication system offering specific services to specific persons bears a portable memory device with a record of personal information such as the bearer's identification number, class of service, personal data, etc. In making a call, the bearer of the memory device puts it on a communication terminal device and the terminal device reads out the personal information, which is transferred to a data processor such as a central processor in the exchange so that a service specific to the calling person is rendered.

The abstract of U.S. Publication No. 20070136202 states:
An access-permission-information issuing unit issues access permission information for accessing personal information on a user, in response to a request from a personal terminal of the user. A personal-information notifying unit notifies a destination terminal of the personal information corresponding to the access permission information, under conditions that the destination terminal that received the access permission information from the personal terminal presents the access permission information.

### SUMMARY

To mitigate the risk of personal information theft and to prevent criminals from easily exploiting vulnerabilities of Internet services, an effective and flexible personal information management and delivery scheme (PIMDS) is established as an Internet service. The PIMDS uses two methods, Master mode and Delegation mode, to convert the traditional message Pushing format to the message Pulling format, in which the data owner can specify the message usage and access control, thereby having total and instant control of the personal information processing in terms of who may access the information and when and where the access may occur.

The personal information management and delivery service utilizes effective encryption and decryption technology in a variety of scenarios and is applicable to any context or situation in which establishment and delivery of sensitive and private personal information is required. For instance, the PIMDS can be integrated into the process flow of a business transaction, in particular the logistics, enabling a buyer to make online purchases of products without having to provide explicit personal data to the seller, whereas the seller can still deliver the products through the logistics provider to the buyer with the encrypted information obtained from the Internet service of PIMDS. Similarly, if a seller would like to protect its own personal information during product delivery, the seller can also subscribe to the Internet service of PIMDS, obtain encrypted information, and provide it to the logistics provider without revealing its identity to the buyer. The Internet service of PIMDS can effectively avoid the need for personal information to be provided for each online transaction, which may result in the personal information being collected or duplicated by the online transaction service provider or others, creating potential privacy and security problems.

In a general aspect, a computer-assisted method for electronic commerce includes accepting, from a first entity, a request to encrypt personal information associated with the first entity, the request including a first specification of the personal information to be encrypted. The method further includes forming an encrypted specification of the personal information according to an encoding strategy and accepting, from a second entity, a request to decrypt the encrypted specification of the personal information. Upon determining that the second entity is an authorized personal information receiver, the method also includes forming a decrypted specification of the personal information according to a decoding strategy determined based on an analysis of the encrypted specification; and providing the decrypted specification of the personal information to the second entity.

Embodiments may include one or more of the following.

The request to encrypt personal information includes a specification of the encoding strategy to be used to form the encrypted specification of the personal information.

The encoding strategy includes a public key infrastructure encoding strategy.

The method further includes storing the encrypted specification of the personal information in a storage cache.

The request to decrypt the encrypted specification of the personal information includes the encrypted specification of the personal information.

The method further includes providing the encrypted specification of the personal information to the first entity.

The personal information includes at least one of a name, a telephone number, an address, financial information, medical information, or a username and password. The second entity includes at least one of a logistics service provider, a cash flow service provider, a professional intermediaries service provider, or a medical information service provider.

In another general aspect, a computer-assisted method for electronic commerce includes accepting, from a first entity, a request to encrypt personal information associated with the first entity, the request including a first specification of the personal information to be encrypted. The method also includes forming an encrypted specification of the personal information according to an encoding strategy; providing the encrypted specification of the personal information to the first entity; and accepting, from a second entity, a request for the personal information associated with the first entity. The method further includes providing the accepted request for the personal information to the first entity; receiving the personal information from the first entity; and providing the received personal information to the second entity.

Embodiments may include one or more of the following.

The accepted request for the personal information includes the encrypted specification of the personal information.

In a further general aspect, a computer-assisted method for electronic commerce includes accepting, from a first entity, a request for personal information associated with a second entity; sending, to the first entity, encrypted data associated with the request for personal information; receiving, from the second entity, an encrypted specification of the personal information; providing the encrypted specification of the personal information to the first entity.

Embodiments may include one or more of the following.

The request for personal information includes an access identifier. The request for personal information includes an identification of a type of personal information.

The method further includes storing the received encrypted specification of the personal information

In another general aspect, the first entity has full control of the personal information in terms of what, when and how the personal information is to be used by the second entity. The second entity who requests the use of personal information, and the first entity who requests the transmission of personal information, are both authenticated by a personal information service manager, before the transmission and delivery of personal information is performed. The personal information service provider or any other intermediate personal information handlers in the transaction work flow will keep only the minimal information, encrypted or otherwise, as needed, avoiding personal information aggregation and layer by layer spreading problems.

Advantages of the personal information management and delivery scheme may include one or more of the following. The PIMDS focuses on the establishment of a flexible and effective personal information processing scheme that can be controlled by an individual in real-time. This new type of Internet service for personal information processing supports alternate online services that may incur potential privacy and security threats, including the heavy concentration problem in which a cache of personal information plaintext may be accessible to unscrupulous persons and the layer by layer spreading problem in which personal information plaintext is duplicated for each of a series of online transactions.

Other features and advantages of the invention are apparent from the following description, and from the claims.

### DESCRIPTION OF DRAWINGS

FIG. 1 shows a message pushing format for a personal information management and delivery scheme.

FIG. 2 shows a message pulling format for a personal information management and delivery scheme.

FIG. 3 is a flowchart for delivery service action of a personal information service.

FIG. 4 is a flowchart for an acquisition service action of a personal information service.

FIG. 5 is a block diagram of a personal information service used for authentication.

FIG. 6 shows a communication diagram for master mode of personal information service used for E-commerce and logistics service.

FIG. 7 shows a communication diagram for delegation mode of personal information service used for E-commerce and logistics service.

FIG. 8 is a communication diagram for a master mode PI delivery service action used for a check-out process and cash flow service.

FIG. 9 is a communication diagrams for a master mode PI acquisition service action used for a check-out process and cash flow service.

### DESCRIPTION

### 1 Overview

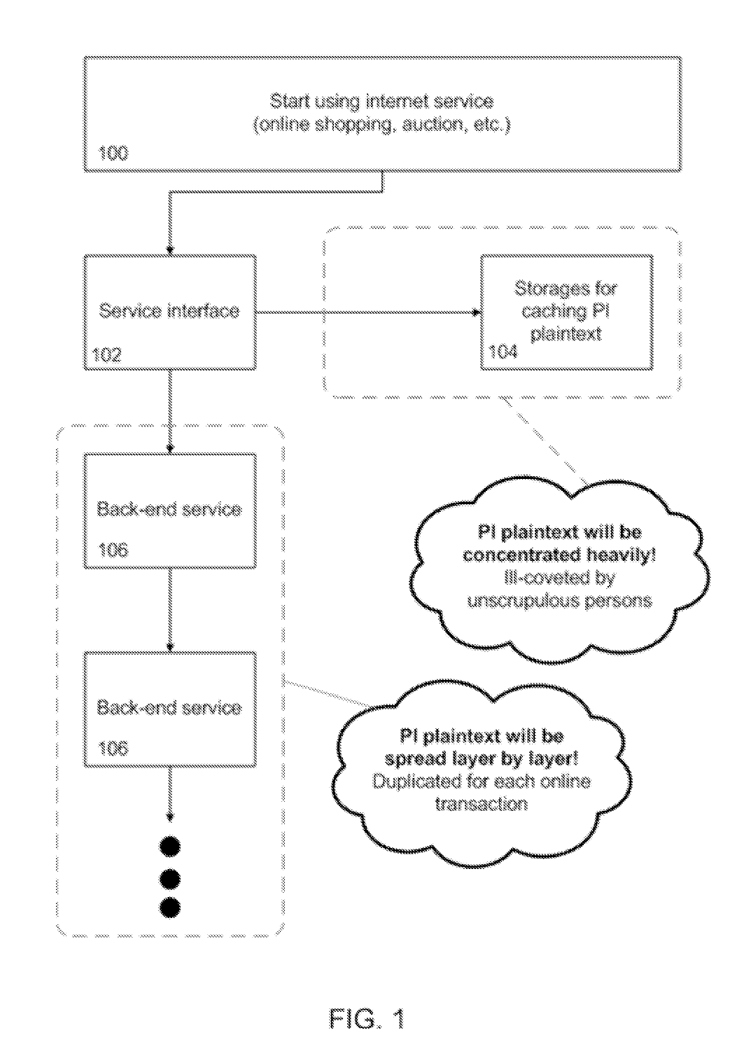

Referring to FIG. 1, a message pushing format is used for personal information management and delivery. In general, personal information (PI) plaintext is provided by a user while using Internet services 100. An Internet service provider 102 often stores the personal information plaintext for personalization, caching in a storage 104, carrying out the purpose for which the data was collected, or transmitting the PI plaintext to back-end services 106 (such as product suppliers). The message pushing format for delivering personal information can result in what is known as a heavy concentration problem, in which PI plaintext is densely concentrated in storage 104, making such storage a prime target for unscrupulous Internet users. Message pushing also results in a layer by layer spreading problem, in which PI plaintext is duplicated each time the information is transmitted to a back-end service 106. The layer by layer spreading problem is compounded for each successive online transaction.

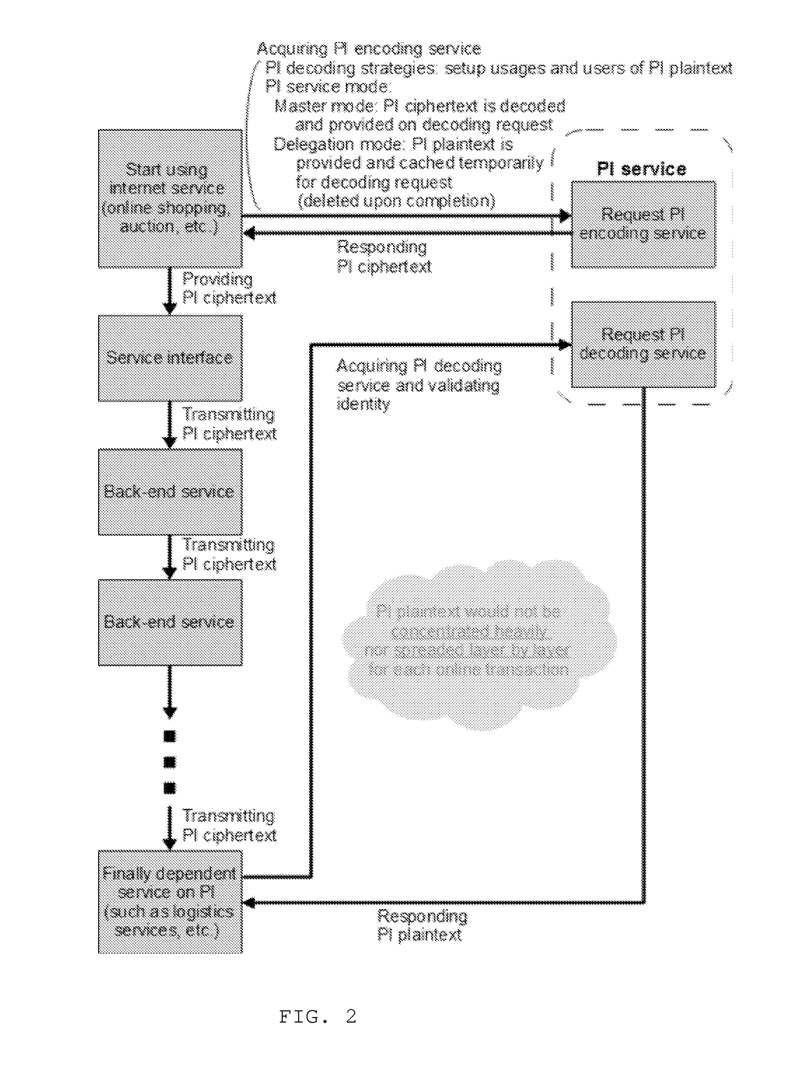

Referring to FIG. 2, in a message pulling format for PI management and delivery, the risk of PI theft is mitigated. With message pulling, a user requests a PI ciphertext from a PI service by assigning PI decoding strategies (i.e., by establishing usages and users of PI plaintext) and designating a PI service mode (master mode or delegation mode). In master mode, PI ciphertext is decoded and provided upon a decoding request; in delegation mode, PI plaintext is provided and cached temporarily in PI service for serving a legal decoding request, and is deleted upon PI service completion or when the PI service registry object becomes out-of-date. By implementing a message pulling scheme, personal information does not need to be provided repeatedly for each online transaction, avoiding potential privacy and/or security problems that may arise by personal information being collected or duplicated by the online transaction service provider or others. More specifically, the heavy concentration and layer by layer spreading problems can be minimized or eliminated.

In general, there are three main actors or user roles in a personal information service (PI service) infrastructure: a PI provider, a PI consumer, and a PI service manager. Most basically, there are two service actions: delivery of personal information and acquisition of personal information, both of which fall generally under the category of data migration between PI providers and PI consumers.

The PI provider and the PI consumer make use of PI service client side software to access the PI service, which is managed by the PI service manager using server side software components. The PI provider is a user who manages PI data in an electronic device and delivers the PI data according to a PI service Universal Resource Identifier (URI) via a PI service client side application. The PI consumer is a user who acquires certain PI data according to a PI service URI via a PI service client side application and views the data in an electronic device.

The PI service URI is a resource identifier or resource access token for a PI service protocol with the following convention: pi_service://userid:ssruid/action, where userid is an identifier in the PI service of a user who creates a registry item identified by ssruid; ssruid is a PI service request universal identifier; and action is a PI service (either acquire or deliver). In some embodiments, the PI service URI can be translated into QR-code for communication with mobile phones, or similar communication devices, having PI service client interaction support.

The PI service can be operated in either master mode or delegation mode.

In general, both PI providers and PI consumers can send a PI service request to obtain a PI service URI string or, in some cases, a QR-code encoding of the URI string. A PI service client user who obtains a PI service URI can use the URI to acquire or deliver PI data according to the convention specified in the URI and the settings of a corresponding registry object (discussed in greater detail below) that is managed by the PI service manager on the server side. The PI data is delivered following the PIMDS approach, ensuring that PI data is not collected or duplicated on the information propagation channel.

### 2 Modes of Operation

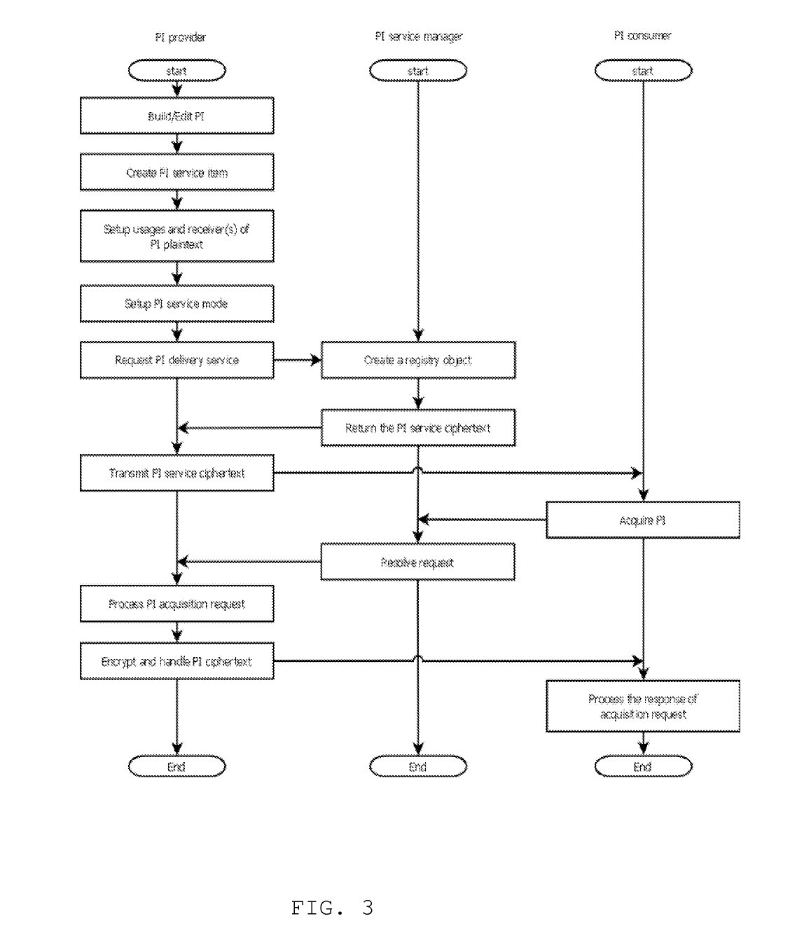

Referring to FIG. 3, in general, in a personal information service with delivery service action, a user creates or edits a personal information context. When needed, the user can then request the specific personal information item from the personal information service. After sending a request with descriptions of usages, senders of PI plaintext, PI decoding strategies, service mode, etc., a registry object is created and the user receives a context of PI service ciphertext. The user can then make use of Email or another communication protocol to transmit this PI service ciphertext to a proper PI consumer. The PI consumer is then able to send a PI acquisition request according to the PI service ciphertext. At the end of the delivery service action of PI service procedure, the PI service manager (in the case of delegation mode) or the PI provider (in the case of master mode) accepts the authenticated PI acquisition request only if it conforms to the PI decoding strategies that were previously assigned by the PI service requestor and the referenced information from PI consumer has been confirmed.

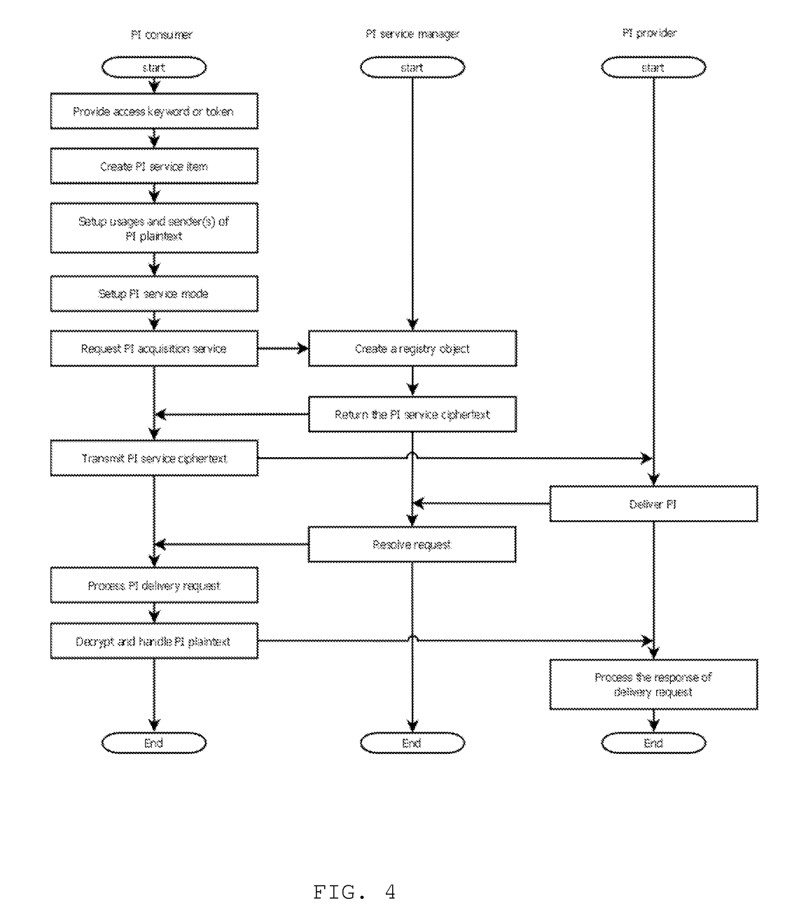

Referring to FIG. 4, in general, in a personal information service with acquisition service action, a user provides access keywords or token. When needed, the user requests the specific personal information item from the personal information service. After sending a request with descriptions of usages, senders of PI plaintext, PI decoding strategies, service mode, etc., a registry object is created and the user receives a context of PI service ciphertext. Then user can make use of Email or another communication protocol to transmit this PI service ciphertext to a proper PI provider. The PI provider is then able to send a PI delivery request according to the PI service ciphertext. The PI provider accepts the authenticated PI acquisition request only if the provided acquisition request information conforms to the PI decoding strategies that were previously assigned by the PI service requestor and the referenced information from PI consumer has been confirmed. At the end of the acquisition service action of PI service procedure, the PI service manager temporarily maintains the encrypted PI. The PI consumer may acquire the encrypted PI at a later time. In the case of master mode, the PI consumer decrypts and processes the PI delivery request directly.

To request PI delivery in master mode, a PI provider accesses the PI service and designates that master mode operation is desired. The PI provider also provides information about access controls, including who is allowed to access the provider's personal information and how the access may be obtained. The PI provider then forwards the PI request (e.g., from an e-commerce website) to the PI service using a client side PI service application and receives in return a PI service URI, such as pi_service://pi_provider:3a253201ce132ebbcc506dd2cc83a266/deliver, that represents the PI service registry corresponding to the particular PI request.

A PI consumer obtains the PI service URI from the PI provider via a communication channel such as Email, an Internet service, instant messaging, or a smartphone application. In some cases, the PI service URI is encoded using QR code. In these cases, the PI consumer uses a PI service client side application with a QR code decoder (e.g., a mobile phone application) to scan the QR code encoded URI. By carrying the PI service URI to the PI service, the PI consumer will initiate a PI service request.

The PI service manager maintains a resolving record, which is a data model for keeping track of information related to who, where, when, and other information related to the user who sends a request to resolve a specific ssruid related to a registry object. The resolving record data model may contain the following attributes:

RequestorIP: The IP address of the requestor
requestorID: The username of the requestor in the PI service
requestorAgentName: The PI service client agent name that makes the resolving request record
requestDate: The date on which the resolving request record was created
gpsLocation: GPS information representative of a location of the requestor
ssruid: The PI service request universal identifier for a registry object with which the requestor will interact
requestPIType: The type of PI with which the requestor will interact
requestPIKey: The keyword of the PI with which the requestor will interact

When the PI consumer initiates the PI service request, the PI service manager checks the service mode in a corresponding registry and, in the case of master mode, forwards the request to the PI provider. The registry is a server side data model that manages the state of a PI service request from a PI service client. The registry data model may contain the following attributes:

state: The state of the registry object (e.g., {“Pending”, “Cancelled”, “Finished”, “Time Out”})
service mode: The service mode of the registry object ({“Master”, “Delegation”})
serviceAction: The service action of the registry object ({“Acquire”, “Deliver”})
ssruid: The PI service request universal identifier
userid: The user identifier
submitDate: The submit date of the registry object
dueDate: The due date of the registry object
clientIP: The IP address that is used by the user for submission of the registry object
clientAgentName: The name of the PI service client agent used for submission of the registry object
pilmageType: The type of PI for the registry object
pilmageBytes: The PI data content in the form of bytes for the registry object
doNotify: A Boolean decision for notifying a user with the ciphertext (or with a PI service URI) encoded for the registry object
notification: The notification contents and protocol assignment that may be sent via Email, instant messaging, or other messaging protocol
resolvingRecords: A list of records that has been resolved for decoding the registry object

The PI provider receives a PI acquisition request with a resolving record that provides information regarding who wants to acquire a particular piece of PI data and when and where the acquisition will occur. The PI provider replies to the acquisition request with “yes” or “no” and, if “yes,” with the PI data that is to be delivered. If “yes,” the PI consumer receives a PI service message including the provided PI data encrypted by the private key of the PI provider and the public key of the PI consumer. The PI consumer decrypts the PI data first with his private key and then with the public key of the PI provider. At this point, the delivery process for the piece of PI data from the PI provider to the PI consumer is successfully completed.

More specifically, for message encryption and decryption, public key infrastructure is generally used. For instance, when a user Alice obtains a PI service URI, e.g., pi_service://bob:ssruid/acquire, then Alice uses
Encrypt_{publicKey(Bob)}(Encrypt_{privateKey(Alice)}(message))
   to encrypt the message that is being read by Bob. When Bob receives the encrypted message, Bob uses
Decrype_{publicKey(Alice)}(Decrypt_{privateKey(Bob)}(message))
   to decrypt and verify the message before proceeding to further steps.

In some instances, a notification is sent via a messaging protocol to certain users who were specified by the registry owner. The notification data model may contain the following attributes:

ssruid: The ssruid related to the notification object
protocolString: A protocol string that specifies the protocol or URLs for delivery of the notification message. For instance, the RFC2368 mailto URL scheme is one type of notification delivery support.
subject: The subject of the message about the notification object
remarks: The body of the message about the notification object
status: The status of the notification object (i.e., {“pending”, “sent”, “resent”, “exception”})

### 3 Use Cases

### 3.1 Authentication

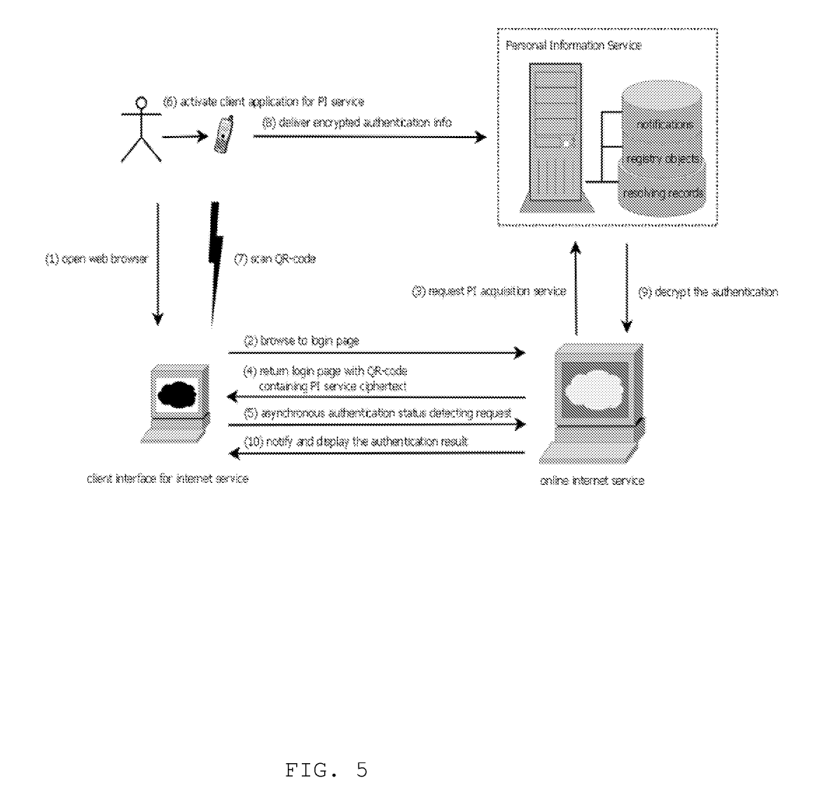

A PI service can be established for serving user id and password as an example of a challenge/response authentication system. Referring to FIG. 5, a credential of a challenge/response system is delivered from a PI service provider and stored in a mobile phone or a similar communication device, of a user upon registration of the mobile phone in an online service. Alternatively, the mobile phone may have PI service authentication capability and thus can deliver a required credential or other legal response to a specific challenge that is acquired by service provider upon login to an online service. An example PI service that supports authentication process is as follows: User first open a browser (step 1). The browser the send request to browse to the login page (step 2). The online Internet service then requests for PI acquisition service (step 3). A login page with QR-code is returned containing PI service ciphertext (step 4). An asynchronous authentication status detecting request is created (step 5). User then activates client application for PI service (step 6). Then use the smart phone to scan the QR-code displayed in step 4 (step 7). User can then deliver the encrypted authentication information (step 8). The personal information service then forward and decrypt the authentication information by on line internet service component (step 9). Then the notification of authentication result is displayed (step 10). The PKI nature established by the underlying PI service helps improve authentication security by assuring non-repudiation property and mutual authentication processes between an identified service domain and a registered user. Users who utilize the PI service authentication scheme through a mobile phone or a similar communication device, can certify the service domain automatically, then deliver the required authentication response or tokens securely to the service provider. Service providers who utilize the PI service authentication scheme can restrain abnormal attackers without needing a private key for the PI service.

### 3.2 Logistics

Either master or delegation mode of a PI service can be utilized for serving a user's contact information as the PI needed by a logistics service supporting common online shopping or auction services.

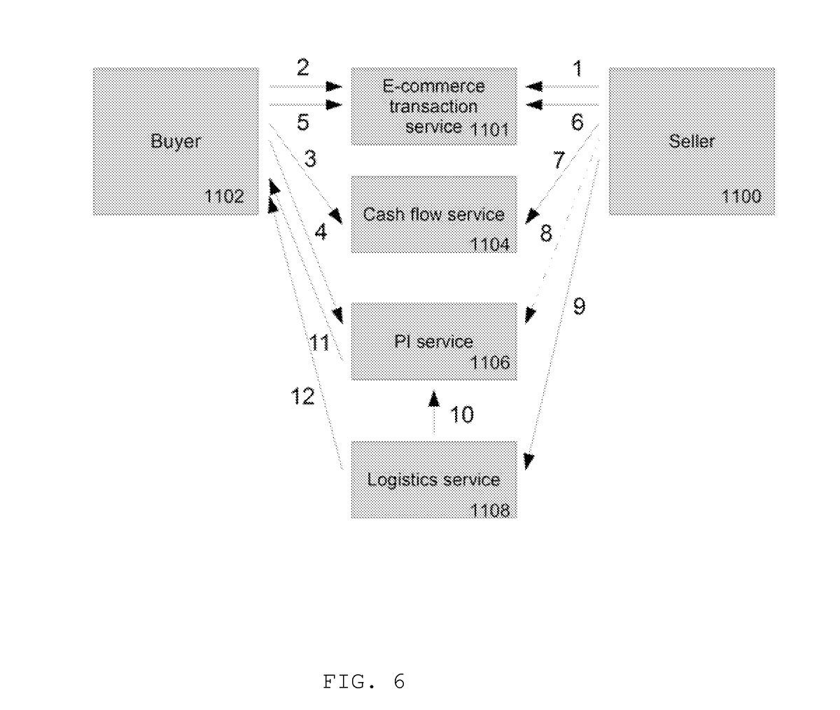

Referring to FIG. 6, a communication diagram for the master mode of the personal information service shows an example of how the master mode is used with common online shopping or auction services. A seller 1100 first publishes items through an e-commerce transaction service 1101, such as an online shopping service (step 1). A buyer 1102 places and completes an order through the online shopping service (step 2). The buyer 1102 then uses a cash flow service 1104 to complete payment for the order (step 3). The buyer uses a PI service 1106 to request a PI ciphertext by assigning a PI decoding strategy, designating the master mode of PI service (step 4). The buyer 1102 reports transaction information, cash flow information, and context of ciphertext for logistics to the seller 1100 (via a communication channel between buyer and seller that is provided by the online shopping service provider, Email, or any other messaging protocol; step 5). The seller then obtains updated transaction information from the online shopping service 1101 (step 6) and verifies the payment record at the cash flow service 1104 (step 7). If the seller wants to protect its own personal information from being known by the buyer, the seller may also utilize PI service 1104 as described in step 4, using the ciphertext in the sender column while using a logistics service 1108 (described in greater detail below; step 8). The seller uses logistics service 1108 to send a transaction item that has a PI ciphertext in the receiver column (step 9). During the delivery process of goods, the logistics service provider 1108 sends a decoding request to the PI service provider 1106 and receives authentication (step 10). The PI service provider recognizes that the PI ciphertext associated with the decoding request designates the master mode, and forwards the request to the PI service requestor (i.e., the buyer) to obtain the corresponding PI plaintext. The buyer checks the decoding request information and confirms to return the PI plaintext via PI service request device (step 11). The logistics service provider 1108 receives the PI plaintext from the buyer and continues the delivery process to the buyer, completing the transaction (step 12).

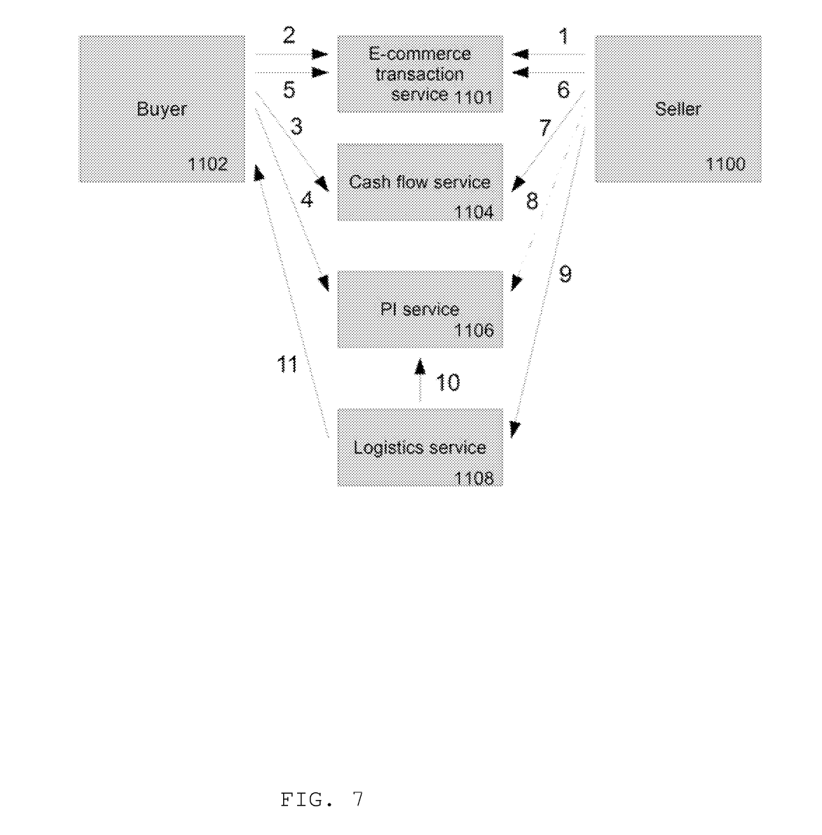

Referring to FIG. 7, a communication diagram shows an example of the delegation mode of the personal information service. The concept of FIG. 12 is similar to that of FIG. 11 with differences in step 4, step 10, and step 11. In step 10, the buyer uses the PI service to request a PI ciphertext by assigning PI decoding strategies, delegating the desired mode of PI service. In step 10, the PI service recognizes that the PI ciphertext has designated the delegation mode for the PI service request. The PI service responds with PI plaintext to the decoding request from a temporarily stored PI service registry. In step 11, the logistics service provider 1108 receives the PI plaintext and continues the delivery process to the buyer, completing the transaction.

### 3.3 Cash Flow Transactions

PI service for both delivering and acquisition can be used to support cash flow applications to improve the transmission of financially related PI.

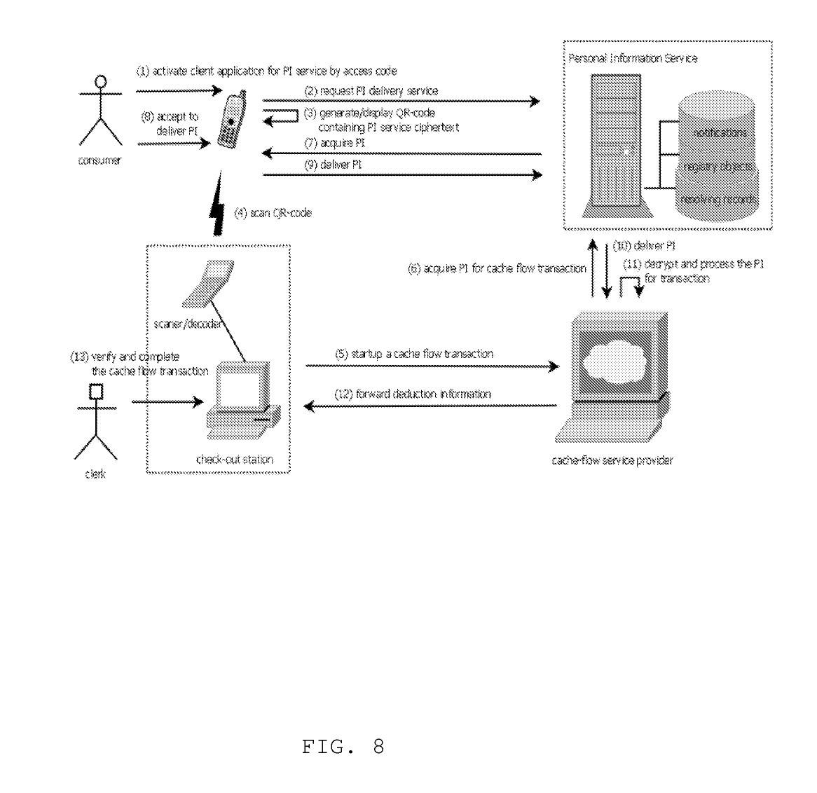

Referring to FIG. 8, in a PI delivery scenario of a checkout process in master mode, a consumer 1300 enters an access code to start using a smart phone application for a PI service on a mobile phone 1302 (step 1) or a similar communication device. The consumer then requests a PI service for delivery of personal information (step 2). The request is forwarded to a PI service manager 1304. A PI service URI, such as pi_service://buyer_userid:ssruid/deliver is returned and displayed as, e.g., a QR-code (step 3). A clerk 1306 uses a QR decoder 1308 to read the QR code displayed on the mobile phone 1302 (step 4). An acquisition request is then sent to an identity provider 1310 (step 5) and forwarded to the PI service manager 1304 (step 6). The request is identified according to a registry that was previously created by consumer 1300. The request is then forwarded to the mobile phone 1302 (step 7). The consumer identifies that the request is legal and accepts to deliver the PI (step 8). The encrypted PI is forwarded to the identity provider 1310 via the PI service (steps 8 and 9) where it is decrypted (step 11). The decrypted information is sent to a check-out station 1312 such that the clerk 1306 can handle and complete the check-out process (step 12, 13).

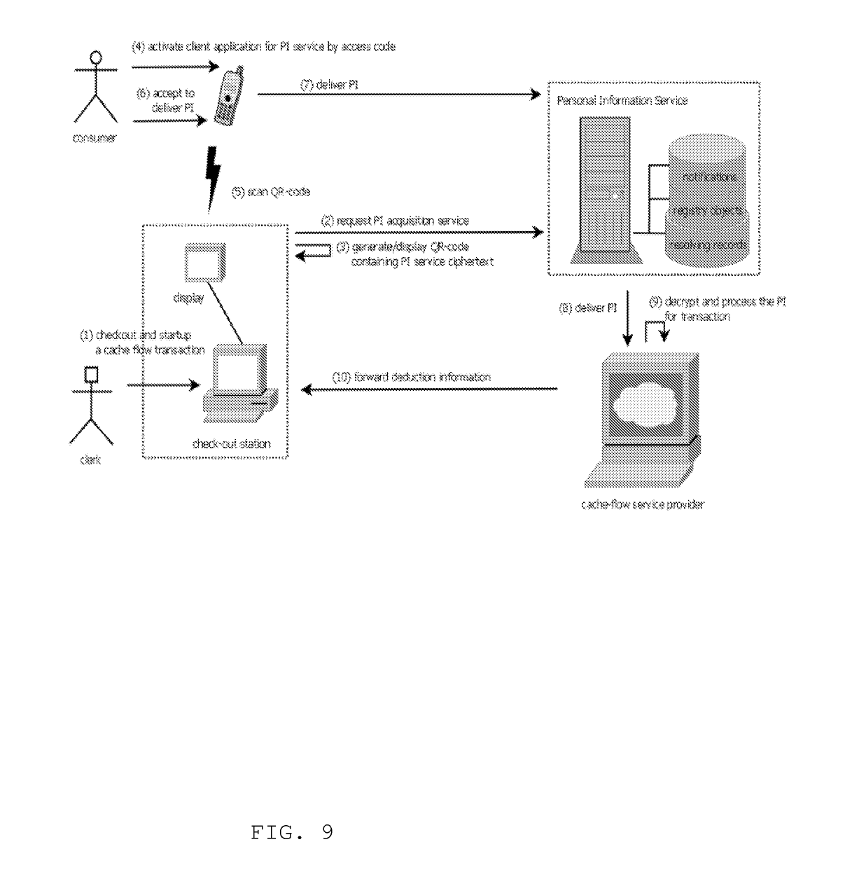

Referring to FIG. 9, in a PI acquisition scenario of a checkout process in master mode, clerk 1306 proceeds to a check-out process at check-out station 1312 android (step 1). The clerk 1306 requests a PI service for acquisition of PI (step 2). The request is forwarded to the PI service manager 1304 (step 3) and a PI service URI, such as pi_service://check_out_station_userid:ssruid/acquire is returned and displayed as, e.g., a QR-code (step 4). The consumer 1300 uses a mobile phone 1302 or a similar communication device, to read the QR-code displayed on the QR decoder 1308 and enters an access code to initiate the delivery of PI (step 5). The consumer agrees to deliver PI relevant to the check-out process (step 6). The delivery request is forwarded to the PI service manager 1304 (step 7), identified according to a registry that was previously created by the check-out station 1312, and forwarded to the identity provider 1310 (step 8). The encrypted PI is then also forwarded to the identity provider 1310 to complete the cash flow transaction after decrypting the ciphertext PI (step 9). The decrypted information is sent to the check-out station 1312 such that clerk 1306 can handle and complete the check-out process (step 10).

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention.

What is claimed is:

1. A computer-assisted method for electronic commerce comprising:
accepting, from a first entity, a request to encrypt personal information associated with the first entity, the request including a first specification of the personal information to be encrypted;
forming an encrypted specification of the personal information according to an encoding strategy;
accepting, from a second entity, a request to decrypt the encrypted specification of the personal information;
upon determining that the second entity is an authorized personal information receiver, forming a decrypted specification of the personal information according to a decoding strategy determined based on an analysis of the encrypted specification; and
providing the decrypted specification of the personal information to the second entity.

2. The computer-assisted method of claim 1, wherein the request to encrypt personal information includes a specification of the encoding strategy to be used to form the encrypted specification of the personal information.

3. The computer-assisted method of claim 1, wherein the encoding strategy includes a public key infrastructure encoding strategy.

4. The computer-assisted method of claim 1, further comprising storing the encrypted specification of the personal information in a storage cache.

5. The computer-assisted method of claim 1, wherein the request to decrypt the encrypted specification of the personal information includes the encrypted specification of the personal information.

6. The computer-assisted method of claim 1, further comprising providing the encrypted specification of the personal information to the first entity.

7. The computer-assisted method of claim 1, wherein the personal information includes at least one of a name, a telephone number, an address, financial information, medical information, or a username and password.

8. The computer-assisted method of claim 1, wherein the second entity includes at least one of a logistics service provider, a cash flow service provider, a professional intermediaries service provider, or a medical information service provider.

9. A computer-assisted method for electronic commerce comprising:
accepting, from a first entity, a request to encrypt personal information associated with the first entity, the request including a first specification of the personal information to be encrypted;
forming an encrypted specification of the personal information according to an encoding strategy;
providing the encrypted specification of the personal information to the first entity;
accepting, from a second entity, a request for the personal information associated with the first entity;
providing the accepted request for the personal information to the first entity;
receiving the personal information from the first entity; and
providing the received personal information to the second entity.

10. The method of claim 9, wherein the accepted request for the personal information includes the encrypted specification of the personal information.

11. A computer-assisted method for electronic commerce comprising:
accepting, from a first entity, a request for personal information associated with a second entity;
sending, to the first entity, encrypted data associated with the request for personal information;
receiving, from the second entity, an encrypted specification of the personal information;
providing the encrypted specification of the personal information to the first entity.

12. The method of claim 11, wherein the request for personal information includes an access identifier.

13. The method of claim 11, wherein the request for personal information includes an identification of a type of personal information.

14. The method of claim 11, further comprising storing the encrypted specification of the personal information.
